(19) United States
(12) Patent Application Publication
(10) Pub. No.: US 2013/0226862 A1
(43) Pub. Date: Aug. 29, 2013

(54) SYSTEM AND METHOD FOR CREATING MACRO PROFILES

(71) Applicant: Wellpoint, Inc., (US)

(72) Inventors: Rickey Tang, Southwick, MA (US); Atul Apte, North Las Vegas, NV (US); Joseph Panici, St. John, IN (US)

(73) Assignee: WELLPOINT, INC., Chicago, IL (US)

(21) Appl. No.: 13/772,475

(22) Filed: Feb. 21, 2013

Related U.S. Application Data
(60) Provisional application No. 61/603,492, filed on Feb. 27, 2012.

(51) Int. Cl. G06F 17/30

(52) U.S. Cl. CPC G06F 17/30345
USPC 707/609

(57) ABSTRACT

Creating a macro profile of an entity is disclosed. Attribute data associated with an entity is identified from (1) one or more public domain information sources and/or (2) one or more private domain information sources. One or more micro profiles for the entity are generated based on the identified data, each of the micro profiles describing the entity in a single dimension. Transactions associated with the entity and/or interactions between the entity and one or more other entities are monitored. A plurality of the generated micro profiles for the entity is selected. The selected micro profiles are associated to generate a macro profile for the entity, the macro profile describing the entity in multiple dimensions. The monitored transactions and/or monitored interactions are analyzed to identify any discrepancies in the macro profile. The macro profile is updated to account for the identified discrepancies.

### CROSS REFERENCE TO RELATED APPLICATIONS

This application claims priority to U.S. Provisional Patent Application No. 61/603,492, filed Feb. 27, 2012, the entirety of which is incorporated herein by reference.

### FIELD OF THE INVENTION

The systems and methods described herein relate to profiling entities based on public and/or private domain data.

### SUMMARY OF EMBODIMENTS OF THE INVENTION

The present invention is directed to systems, methods and computer-readable media for use in connection with creating macro profiles of entities. Attribute data associated with an entity is identified from one or both of (1) one or more public domain information sources and (2) one or more private domain information sources. One or more micro profiles for the entity are generated based on the identified data, each of the micro profiles describing the entity in a single dimension. One or both of (1) transactions associated with the entity and (2) interactions between the entity and one or more other entities are monitored. A plurality of the generated micro profiles for the entity is selected. The selected micro profiles are associated to generate a macro profile for the entity, the macro profile describing the entity in multiple dimensions. The monitored transactions and/or monitored interactions are analyzed to identify any discrepancies in the macro profile. The macro profile is updated to account for the identified discrepancies.

### BRIEF DESCRIPTION OF THE DRAWINGS

The foregoing summary, as well as the following detailed description of various embodiments, will be better understood when read in conjunction with the appended drawings. It should be understood, however, that the invention is not limited to the precise arrangements and instrumentalities shown.

In the drawings:

FIG. 1 illustrates an exemplary nomenclature for profiles that may be used in connection with an embodiment of the present invention;

FIG. 2 is a flow diagram illustrating an exemplary method for carrying out an embodiment of the present invention;

FIG. 3 is a flow diagram illustrating an exemplary method for carrying out an embodiment of the present invention;

FIG. 4 is a diagram illustrating an example of an entity that may be profiled, the entities with whom that entity may interact, the types of interactions that may occur, and the manner in which data generated through those transactions may be used;

FIG. 5 is a diagram illustrating a method for carrying out exemplary embodiments of the present invention;

FIG. 6 is a diagram illustrating exemplary sources of public and private domain attributes that may be used in connection with the present invention;

FIG. 7 is an diagram illustrating hardware and software that may be used in connection with the present invention;

FIG. 8 is a flow diagram illustrating an exemplary method of the present invention; and

FIG. 9 is a flow diagram illustrating an exemplary method of the present invention.

### DETAILED DESCRIPTION

Described herein is a nomenclature for profiles and a method for compiling context sensitive macro profiles from one or many public or private domain micro profiles. The examples herein are described with reference to creating profiles of entities in the healthcare space. Such entities may include providers (e.g., doctors, hospitals, laboratories, etc.), consumers, clinical staff, insurance products, or employers. However, the invention is not so limited and can be used in any context in which profiling individuals or entities may be useful.

More particularly, the nomenclature for profiles creates two categories of profiles, micro profiles and macro profiles. Micro profiles carry a single dimension of profiled attributes, e.g., demographic attributes of an individual or entity, such as a provider. Macro profiles carry multiple dimensions of profiled attributes, e.g. demographic and performance attributes of an individual or entity, such as a provider.

In one embodiment, the method for compiling context sensitive macro profiles includes three basic steps: In step 1, profile attributes and monitored transaction types are aggregated into micro profiles. In step 2, macro profiles are assembled and discrepancies within assembled micro profiles are assessed. In step 3, the macro profiles are placed into an information technology ecosystem, where they can be used. Each of these steps is described in more detail herein.

In all industries, understanding stakeholders' (e.g., customers', partners', employees') needs is a critical part of business. The process of capturing and analyzing current and future stakeholder needs is increasing in complexity. Information about stakeholder's preferences, behavior, and experiences is typically fragmented across public and private domains. Furthermore, shortened timelines within which stakeholders require action are compounding the problem of presenting the results to decision makers at the right time.

Conventional methods and techniques for researching stakeholder needs and preferences (e.g., surveys) and compiling the resulting information into profiles does not generating the depth of information necessary for comprehensive analysis and generation of actionable insights. As a result, decision makers have limited access to quality insights, thereby affecting decisioning in a highly competitive market.

Changes in health care industry caused by Health Care Reform and associated activities has created a greater demand for deeper understanding of key stakeholders, such as health care providers, patients, and payors. Thus, there is a need for compiling richer and regularly (e.g., continuously) updated profiles and analysis which will lead to deeper understanding of individual stakeholder entities. A nomenclature and categorization of profiles supported by the techniques describe herein for compiling multi-dimension profiles will address the need for holistic, 360 degree views of stakeholders, stakeholder needs, and stakeholder performance.

Techniques are known for creating comprehensive profiles which contain profiled attributes and information supplied by profiled entities. However, such techniques do not create a complete profile. For example, these profiles do not reflect discrepancies resulting from differences in information supplied by profiled entities and real-world actions of entities captured by transactions.

The disclosed method for compiling macro profiles closes this critical gap in known profiling techniques. The separation of micro profiles (single dimension of profiled attributes) from macro profiles (multiple dimensions of profile attributes) allows the compilation method to associate discrepancies with specific micro profiles and also refresh or update micro profiles appropriately.

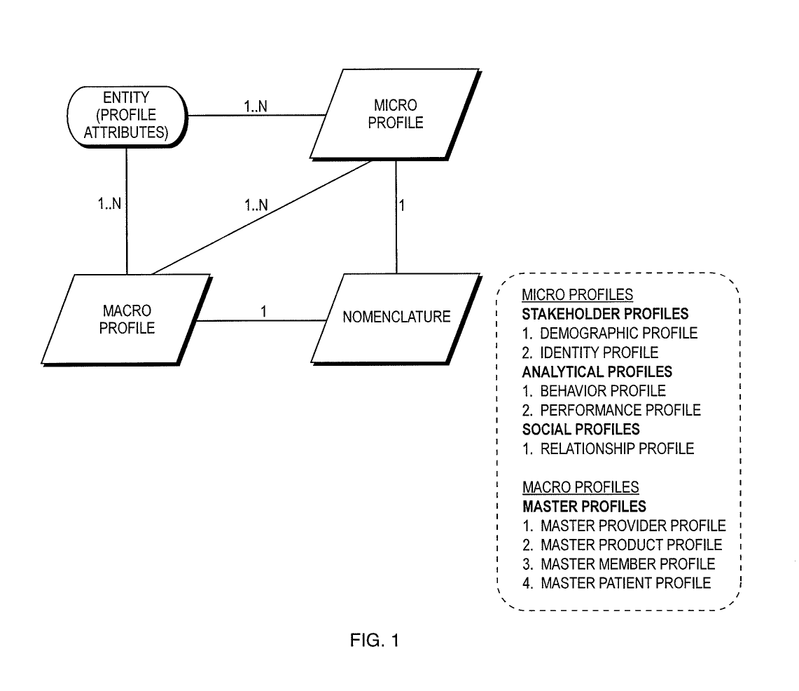

FIG. 1 illustrates an exemplary nomenclature of profiles that categorizes profiled attributes into micro profiles and macro profiles. The basic categories of micro profiles include, by way of example, Stakeholder profiles, which generally indicate roles and responsibilities of the Stakeholder; Analytical profiles, generated by particular analytical processes; and Social profiles, which capture relationships and interactions among the profiled entities.

The following provides two examples of how analytical profiles may be generated. A first example involves demographic analysis of stakeholder profiles, where an existing micro profile is updated. Demographic analysis results in categorization of stakeholder profiles. This results in the addition of categorization attributes to the stakeholder profile. For example, a demographic analysis may uncover general health risk, such as age related risks. A risk indicator indicating the type of health risk is added to the stakeholder profile, which could change the stakeholder profile's category. A second example involves behavioral analysis of stakeholder transactions, where a new micro profile is created (i.e., a behavior profile for the stakeholder). Behavior analytics is a process for analyzing transactions of a stakeholder (e.g., a member) within a specific context (e.g., customer service). The result of this analytical process is a set of new data (e.g., attributes) indicating the level and type of support the stakeholder needs (e.g. personal contact, IVR, Web based services). These new attributes are compiled into a new micro profile for the stakeholder, i.e., a behavior profile.

The nomenclature of macro profiles has a single category of master profiles. In accordance with the systems and methods defined herein, the concept of a macro profile is constrained to a single category, i.e., a master profile. Thus, if a macro profile is created, then it is considered a master profile (unlike micro profiles, which have many categories, e.g., stakeholder, social, analytical). Micro profiles have multiple categories and the macro profile has only one category (i.e., the master profile). There can be several macro profiles but each is a master profile.

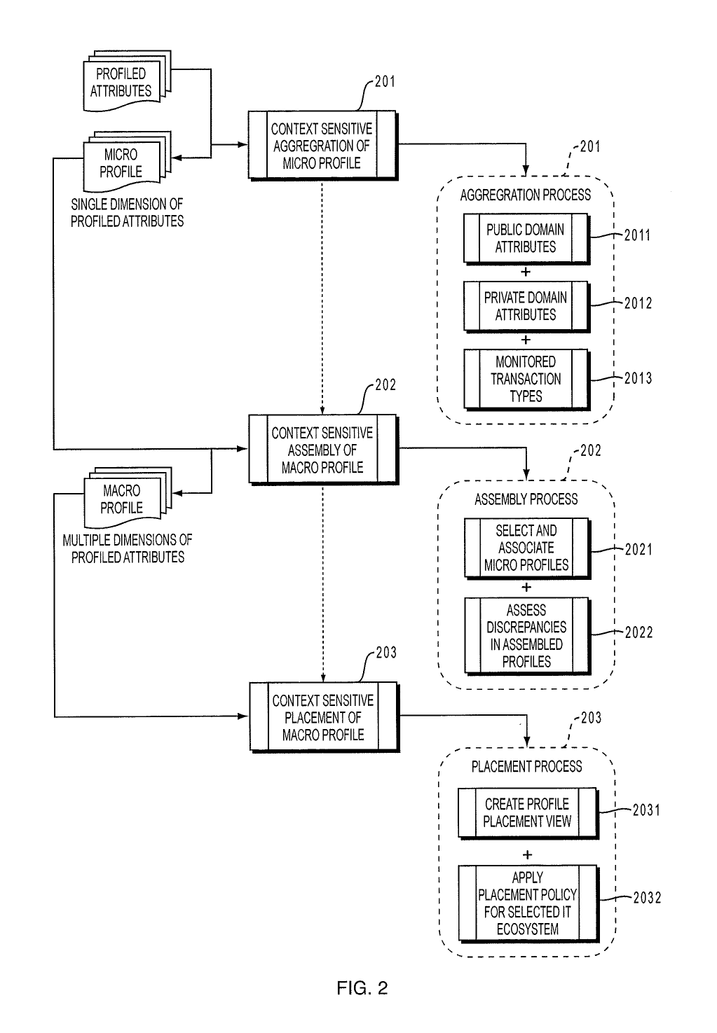

FIG. 2 illustrates an exemplary method for compiling macro profiles. The method and its processes are all context sensitive and result in context sensitive placement of generated context sensitive macro profiles into IT ecosystems. In the scenario of macro and micro profiles, context sensitive refers to aligning profile attributes with context requirements (e.g. compliance with HIPPA regulations). For example, an analytical process may be run to gain insights, but attributes are not maintained in the generated micro profile if they violate privacy regulations. Therefore, a stakeholder profile may not include certain attributes, e.g., such as a social security number or other health information that is protected by HIPPA. The social security number and other data may be used for analysis and during the process of creating or categorizing profiles, but the profile itself will not include protected data.

The exemplary method is comprised of three processes, in one embodiment: an aggregation process for creating micro profiles, in step 201; an assembly process for creating macro profiles, in step 202; and a placement process for placing macro profiles in IT ecosystems, in step 203. The aggregation process of step 201 obtains profiled attributes from public domains, in step 2011, and obtains profiled attributes from private domains, in step 2012, and aggregates them to create a micro profile. Public domain attributes is a category of data that anyone can access without violating any government regulations or individual rights. For example, some data in social networking profiles is considered public data because the profile owner is willing to share that information publically. Other examples of public data include that taken from yellow pages where names and phone numbers are listed and accessible by anyone. Access to such data can be obtained through publicly available means. Private domain data is always associated with the data owner, which can be an individual or an organization. For example, in the insurance context, every member, provider, and payer is a private domain. There is some data created and/or owned by members, providers, and payers. This data could be important to micro and macro profiles and getting access to private data requires consent from data owner. Additional security may be needed to safeguard private data acquired from external owners (e.g., members, providers).

In addition, each micro profile is associated with a transaction type, obtained in step 2013, which is monitored to facilitate continuous updates of the micro profile. The aggregation process is context sensitive and takes into consideration regulations (e.g., protecting health and financial information) and safeguards (e.g., securing externally owned private data) before compiling micro profiles. This ensures that the attributes included in the profile are useful and fully compliant.

The assembly process of step 202 selects and associates micro profiles, in step 2021, to create a specific type of macro profile. In addition, the assembly process assesses discrepancies in the assembled micro profiles, in step 2022. The analysis of transactions relative to the current state of profiled attributes of a micro profile uncovers discrepancies within each micro profile.

Transaction types are categories of interactions between stakeholders. For example, one category of interactions is applying for health insurance, another category of interactions is submitting claims. Both these category of interactions are different transaction types. Each transaction type operates on a set of data and, if the transaction data has any attributes similar to the attributes in a micro profile, then that transaction type is associated with the micro profile.

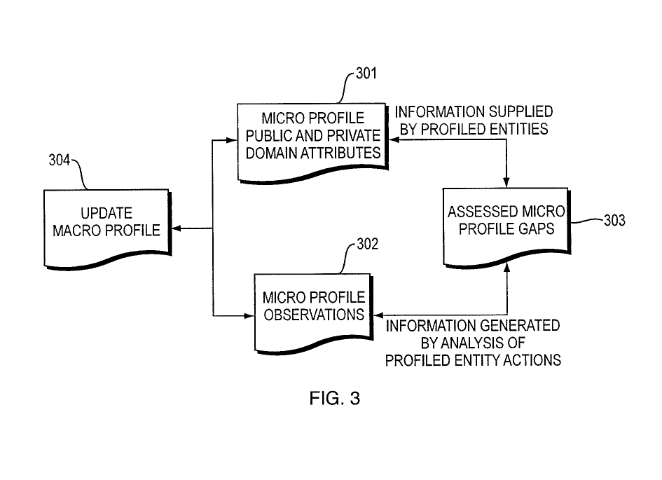

In one embodiment, every transaction type associated with a micro profile is by default marked/selected for monitoring. Monitoring refers to a periodic (e.g., once a month, daily, etc.) analysis of the monitored transaction types. This analysis results in the creation of micro profile observations, where data from transactions is used to validate or invalidate current values of attributes in micro profile. For example, if a stakeholder micro profile has a profiled attribute of “smoking habit” and the current value is “non-smoker”, then the analysis of monitored transactions (e.g., claims) will look for any diagnosis or procedure that indicate that the member is a smoker and create an “observation” to indicate that the “smoking habit =non-smoker” is invalid. On the other hand, if the analysis shows no indication or diagnosis of procedures involving smoking, then an “observation” is created to indicate that the “smoking habit =non-smoker” is valid. FIG. 3 illustrates the role of micro profile observations in this regard.

In particular, FIG. 3 illustrates one process of identifying discrepancies between attributes of different micro profiles. The association and monitoring of transaction types to micro profile attributes results in “observations” that either validate or invalidate the current values of profiled attributes in micro profiles. The process of assessing micro profile discrepancies is to determine whether, for each attribute in the micro profile, there is an “observation” invalidating the current value of the attribute. If yes, then that attribute is tagged as having a discrepancy.

The process of updating micro profiles is, in some embodiments, similar to the aggregation process, except it has the additional ability to remove existing attributes, add new attributes, and change values of existing attributes. The aggregation process only adds new attributes to the micro profile and, hence, is used to create new profiles only.

The macro profile assembly process, in one embodiment, may associate one or many micro profiles with the assembled macro profile. In such embodiments, there is no association between micro profiles (i.e., micro profiles are not associated with each other; instead, they are associated with a macro profile). The selection process for selecting appropriate micro profiles for association with macro profiles may be based on certain selection criteria.

Information regarding transactions comes from other transaction systems, depending on the type of transactions associated with the profiled attributes. It is possible that, in some cases, a transaction type associated with an attribute may not have transaction systems that can provide the transaction data. This is particularly the case if the transaction systems are external to the entity running the system. For example, social profiles may have some attributes which are associated with a transaction type, such as health club visits, weight loss program enrollment and other wellness transaction types. An entity may not have access to transaction systems that can provide the necessary transaction information.

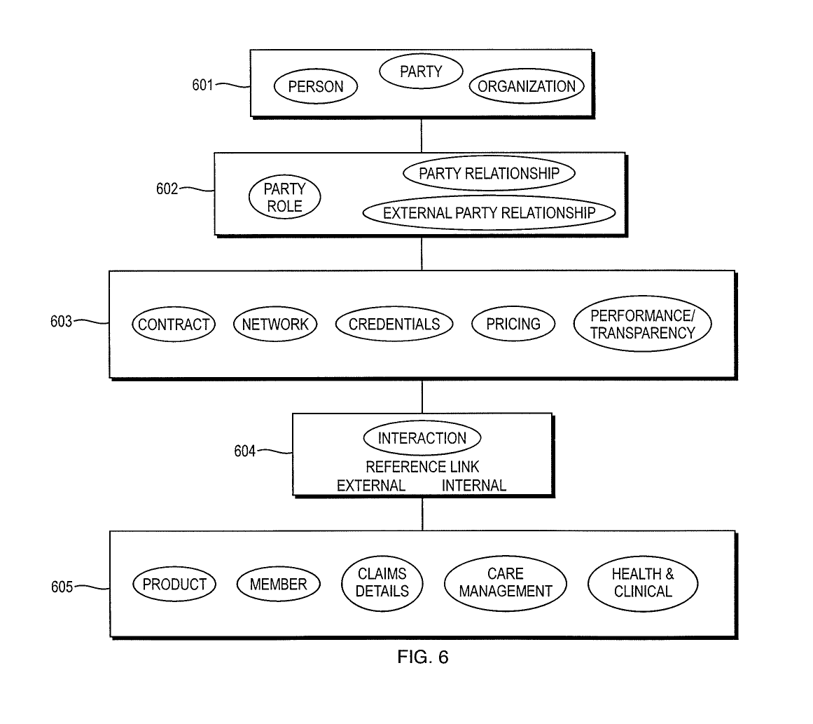

Exemplary sources of information to obtain public and private domain attributes, as well as information regarding transactions and interactions, are described with reference to FIG. 6, below.

Macro profiles provide a comprehensive degree view of profiled entities. Hence, appropriate placement of macro profiles within a selected IT ecosystem is critical ensure regulatory compliance, e.g., in the health care industry. The placement process creates placement specific views of macro profiles and applies relevant placement policies (e.g., HIPPA) based on the selected IT ecosystem. The placement process of step 203 supports three types of IT ecosystems, in one embodiment: public domain ecosystems (e.g., public clouds), private domain ecosystems (e.g., corporate data center), and hybrid ecosystems (e.g., hybrid clouds or custom hybrids such as a corporate data center and public cloud). Thus, in step 2031, a profile placement view is created. In step 2032, a placement policy is applied for a selected IT ecosystem.

By way of further explanation, macro profiles (e.g., a master profile of an entity, such as a provider, member, etc.) are utilized in different scenarios. Some scenarios display or visualize some or all attributes of the macro profile, while other scenarios use some or all attributes of a macro profile as input to automated processes. Generally, this is achieved by creating a specialized (e.g., read-only) view of the macro profiles based on the utilization scenario. The placement view (referred to above) filters out those attributes of the macro profile that are not utilized. In the case of context sensitive placement, a macro profile (e.g., master provider profile) is never copied which ensures that there is only one (i.e., single) true version of every macro profile (e.g., master provider profile). Instead of filtering data and creating a copy (i.e., a data view), context sensitive placement creates a customized view of macro profile access. This access is capable of retrieving the required attributes/data from the macro profile and applying filtering as part of providing the access.

Depending on which segment of the IT ecosystem is going to use the customized view of macro profile access, relevant policies are associated with the access. These policies can restrict the type of attributes and values that can be accessed. Due to this approach, the same macro profile can be accessed from different contexts (internal systems or external systems) where each context can obtain a unique set of attributes from the same macro profile, if necessary. This can be achieved without creating different copies of profile data.

FIG. 3 illustrates an exemplary assembly process (step 2 referred to above and step 202 of FIG. 2), which includes a sub-process to assess discrepancies within each of the assembled micro profiles. The assessment process analyzes current information of the profiled attributes relative to monitored transactions. Thus, in step 301, micro profile attributes are obtained from public and private domain domains. In step 302, profiled entity actions are analyzed to generate information, which information is used in step 303 to assess gaps in the micro profile. In step 304, the macro profile is updated to account for any discrepancies. Thus, micro profile gaps are logged as a result of the assessment process and specific gaps are associated with each micro profile as observations. These observations can be used to update micro profile attributes and close the assessed gaps in profiles. As new transactions take place, the assessment process identifies gaps and updates observations.

Step 3 of the method, referred to above and represented in step 203 of FIG. 2, involves inclusion of macro profiles in the overall method of compiling profiles. Context sensitive placement ensures the proper tenancy of each macro profile in the emerging fragmented IT ecosystem. This new IT ecosystem is composed of public, private, and hybrid ecosystems formed by proprietary data centers and cloud environments. Hence, a method that includes placement of profiles as part of the overall method of compiling macro profiles is a significant advancement of current profile compilation techniques/

In some instances, macro profiles may contain links to micro profiles in public domains.

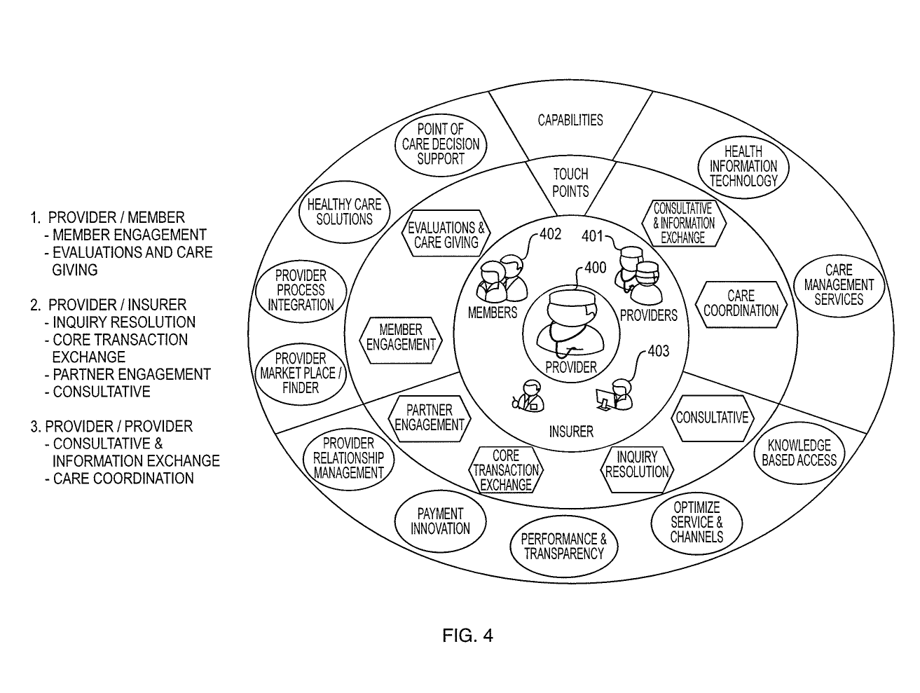

With reference to FIG. 4, an example is shown of relationships and interactions captured in three Social micro profiles. In this example, micro profiles are to be generated for a Provider 400 based on the interactions between Provider 400 and each of other Providers 401, Member 402, and Insurer 403. The interactions between Provider 400 and Providers 401 include those relating to consultation and information exchange and care coordination, by way of example. The data generated as a result of these interactions may be useful in connection with, e.g., data regarding care management services and health information technology. The interactions between Provider 400 and Members 402 include those relating to evaluations and care giving and member engagement. The data generated as a result of these interactions may be useful in connection with, e.g., point of care decision support, health care solutions, provider process integration, and provider market place finder. The interactions between Provider 400 and Insurer 403 include those relating to partner engagement, core transaction exchange, inquiry resolution and consultative interactions. The data generated as a result of these interactions may be useful in connection with, e.g., provider relationship management, payment innovation, performance and transparency initiatives, optimization of service and channels, and knowledge based action initiatives.

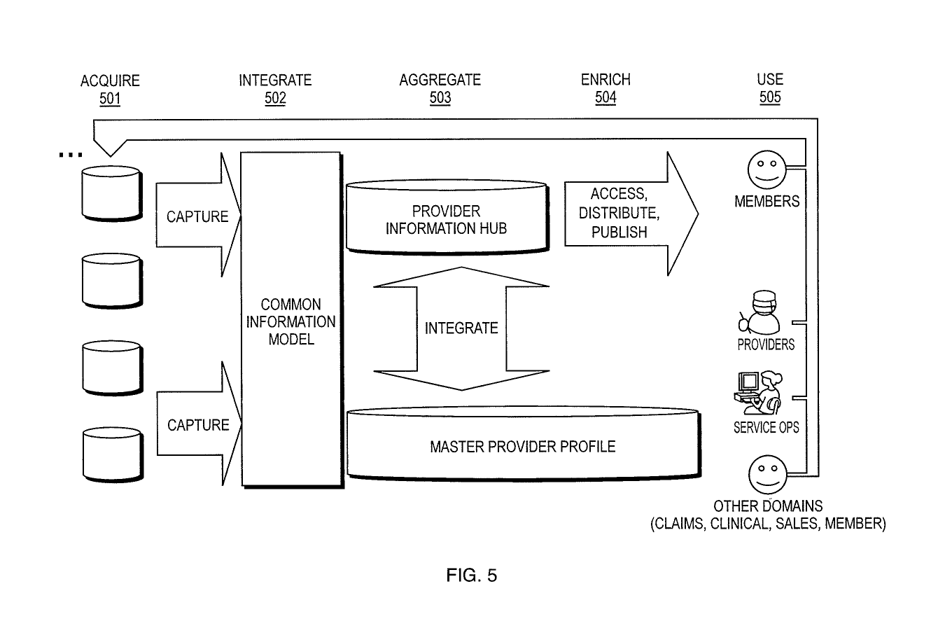

FIG. 5 is a diagram illustrating an exemplary system that may be used to carry out the methods of the present invention. This system is described with reference to creation of a master profile for providers. However, this invention is not so limited and can be used for creating a profile for any individual or entity. Data is acquired from one or more information sources in step 501. Data acquired from multiple sources may exist in each native system in a different format. Thus, in order to make it usable, in some embodiments, the data is integrated in accordance with a common information model in step 502. Then data is aggregated into a provider information hub in step 503, which is used to create the master provider profile. Such information may be enriched in step 504, allowing for access, distribution and publishing. Then, the resulting information can be used by end users in step 505, which may be members (e.g., to locate information about a provider), other providers (e.g., in connection with referrals), insurance companies (e.g., paying on claims), by way of example.

FIG. 6 illustrates an example of Public and Private domain attributes and Proprietary observations in a Master Profile of a provider. The identity 601 of a party to be profiled (e.g., an individual or an entity) is established. In the exemplary embodiment, the party may be associated with an enterprise identifier (i.e., a unique identifier within the system). Data regarding an identity of the party take a variety of different forms, e.g., a name, classification/type of entity, tax ID, location ID, practice characteristic, contact information, services specialties, and professional relationships. Information about the parties' role(s) and relationship(s) 602 is acquired. For example, a person's role may be the type of individual provider (e.g., doctor, nurse, specialist etc.) and an entity's role may be the type of organization (e.g., hospital, lab, pharmacy, etc.). The party's relationships may include person to person relationships (e.g., provider to provider—consultative/information exchange and care coordination; provider to member—member engagement, evaluations and care management; provider to organization—inquiry resolution/core transaction exchange, partner engagement/consultative); person to organization relationships (e.g., individual provider to organization provider, individual provider to organization rep, individual provider to provider organization, and provider to agent/broker); and organization to organization relationships (e.g., provider group to group, or provider group to healthcare facility). Detailed information regarding the party may include contract information (medical service contracts, terms and conditions, reimbursements, programs, and panels/PMG/IPA); network information (network characteristics/locations/geographics); credentials (credentials, certification/recognitions, taxonomies, provider sanctions, and accreditation organizations); pricing (fee schedules and rate cards); and performance/transparency information (provider metrics, member satisfaction metrics, provider survey/feedback). Information about the transactions and interactions 604 of the party to be profiled is obtained. For example, where the party to be profiled is a provider, information regarding the provider's interactions may be captured and reviewed. Such interactions may include those through customer service channels (phone, chat, email, fax, letters, test); self-service channels (realtime, Web/Portals, IVR, and mobile); systems external to the health insurers (consumer groups and associations); care interactions and outreach; and sales and marketing campaigns. In addition, the party's transactions may be monitored and reviewed. Such transactions may include, e.g., claims transactions, utilization management authorizations and referrals, and billing invoices and receivables.

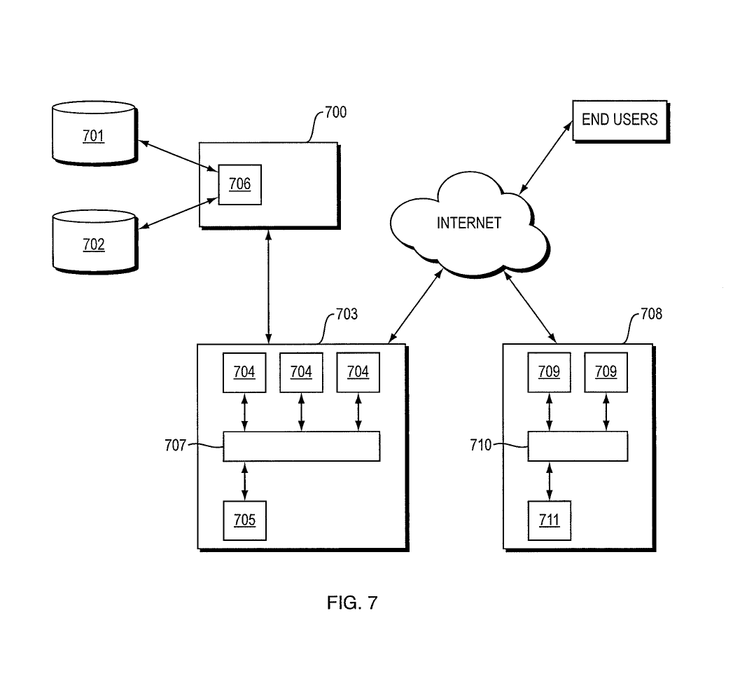

Exemplary hardware and software employed by the systems discussed herein are now generally described with reference to FIG. 7. Database server(s) 700 may include a database services management application 706 that manages storage and retrieval of data from the database(s) 701, 702. The databases may be relational databases; however, other data organizational structure may be used without departing from the scope of the present invention. One or more application server(s) 703 are in communication with the database server 700. The application server 703 communicates requests for data to the database server 700. The database server 700 retrieves the requested data. The application server 703 may also send data to the database server for storage in the database(s) 701, 702. The application server 703 comprises one or more processors 704, computer readable storage media 705 that store programs (computer readable instructions) for execution by the processor(s), and an interface 707 between the processor(s) 704 and computer readable storage media 705. The application server may store the computer programs referred to herein.

To the extent data and information is communicated over the Internet, one or more Internet servers 708 may be employed. The Internet server 708 also comprises one or more processors 709, computer readable storage media 711 that store programs (computer readable instructions) for execution by the processor(s) 709, and an interface 710 between the processor(s) 709 and computer readable storage media 711. The Internet server 708 is employed to deliver content that can be accessed through the communications network, e.g., by an end user. When data is requested through an application, such as an Internet browser, the Internet server 708 receives and processes the request. The Internet server 708 sends the data or application requested along with user interface instructions for displaying a user interface.

The computers referenced herein are specially programmed, in accordance with the described algorithms, to perform the functionality described herein.

The non-transitory computer readable storage media that store the programs (i.e., software modules comprising computer readable instructions) may include volatile and non-volatile, removable and non-removable media implemented in any method or technology for storage of information such as computer-readable instructions, data structures, program modules, or other data. Computer readable storage media may include, but is not limited to, RAM, ROM, Erasable Programmable ROM (EPROM), Electrically Erasable Programmable ROM (EEPROM), flash memory or other solid state memory technology, CD-ROM, digital versatile disks (DVD), or other optical storage, magnetic cassettes, magnetic tape, magnetic disk storage or other magnetic storage devices, or any other medium which can be used to store the desired information and which can be accessed by the computer system and processed.

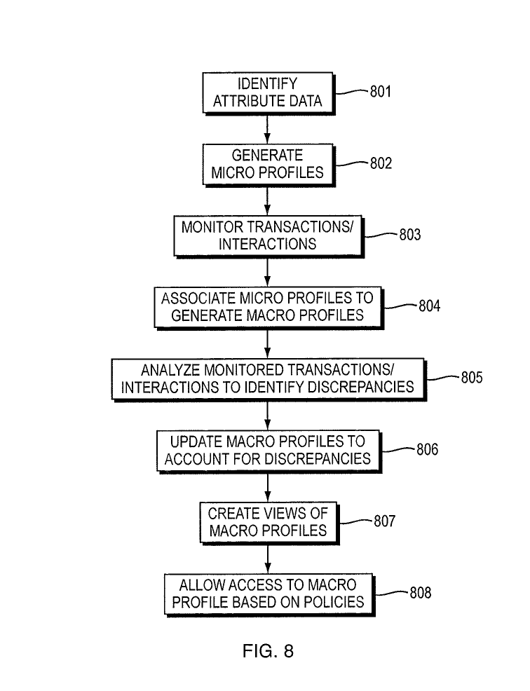

FIG. 8 is a flow diagram illustrating an exemplary method of the present invention.

In step 801, attribute data associated with an entity is identified from one or both of (1) one or more public domain information sources and (2) one or more private domain information sources. The entity may be an individual or an organization. In some embodiments, the identifying is based on a context associated with the identity of the entity.

In step 802, one or more micro profiles for the entity are generated based on the identified attribute data. Each of the micro profiles describes the entity in a single dimension.

In step 803, one or both of (1) transactions associated with the entity and (2) interactions between the entity and one or more other entities are monitored. In some embodiments, the transactions and the interactions are associated with a type and the monitoring is performed based on the type.

In step 804, the selected micro profiles are associated to generate a macro profile for the entity. The macro profile describes the entity in multiple dimensions.

In step 805, the monitored transactions and/or interactions are analyzed to identify any discrepancies in the macro profile.

In step 806, the macro profile is updated to account for the identified discrepancies.

In step 807, one or more views of the macro profile of the macro profile are created. Each view may correspond to an information technology system through which the macro profile can be accessed.

In step 808, access to the macro profile is allowed in accordance with one or more placement policies for the information technology system through which the macro profile can be accessed.

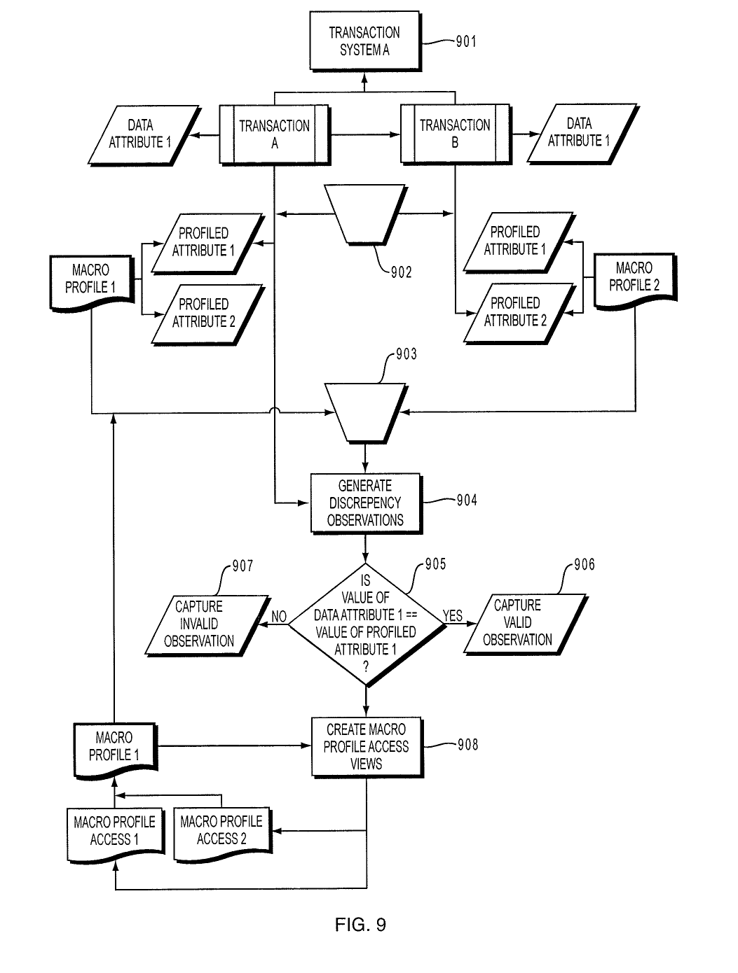

With reference to FIG. 9, a flow diagram illustrating an exemplary method of the present invention is described. In this example, data regarding two transactions—transaction 1 and transaction B—are received, in step 901, from transaction system A. Each of these transactions results in a data attribute. At step 902, transaction A is associated with a micro profile for profiled attribute 1, and transaction B is associated with a micro profile for profiled attribute 2. At step 903, which the micro profile type is associated with the macro profile type. At step 904, discrepancy observations are generated. In step 905 it is determined if the value of data attribute 1 is equal to the value of profiled attribute 1. If so, the observation is considered valid, in step 906. If not, the observation is considered invalid, in step 907. In step 908, the macro profile access views are created (e.g., macro profile access 1 and macro profile access 2), based on macro profile 1. In connection with this step, a profile placement and utilization policy is defined for internal and external IT ecosystems.

What is claimed is:

1. A computer implemented method comprising identifying attribute data associated with an entity from one or both of (1) one or more public domain information sources and (2) one or more private domain information sources;
generating one or more micro profiles for the entity based on the identified data, each of the micro profiles describing the entity in a single dimension;
monitoring one or both of (1) transactions associated with the entity and (2) interactions between the entity and one or more other entities;
selecting a plurality of the generated micro profiles for the entity;
associating the selected micro profiles to generate a macro profile for the entity, the macro profile describing the entity in multiple dimensions;
analyzing the one or both monitored transactions and monitored interactions to identify any discrepancies in the macro profile; and
updating the macro profile to account for the identified discrepancies.

2. The method of claim 1 where the entity is an individual.

3. The method of claim 1 where the entity is an organization.

4. The method of claim 1 wherein the identifying is based on a context, the context being associated with the identity of the entity.

5. The method of claim 1 wherein each of the transactions and the interactions are associated with a type and wherein the monitoring is performed based on the type.

6. The method of claim 1 further comprising:
creating one or more views of the macro profile, each view corresponding to an information technology system through which the macro profile can be accessed;
allowing access the macro profile in accordance with one or more placement policies for the information technology system through which the macro profile can be accessed.

7. A non-transitory computer-readable storage medium that stores instructions which, when executed by one or more processors, cause the one or more processors to perform a method comprising:
identifying attribute data associated with an entity from one or both of (1) one or more public domain information sources and (2) one or more private domain information sources;
generating one or more micro profiles for the entity based on the identified data, each of the micro profiles describing the entity in a single dimension;
monitoring one or both of (1) transactions associated with the entity and (2) interactions between the entity and one or more other entities;
selecting a plurality of the generated micro profiles for the entity;
associating the selected micro profiles to generate a macro profile for the entity, the macro profile describing the entity in multiple dimensions;
analyzing the one or both monitored transactions and monitored interactions to identify any discrepancies in the macro profile; and
updating the macro profile to account for the identified discrepancies.

8. The non-transitory computer-readable storage medium of claim 7 where the entity is an individual.

9. The non-transitory computer-readable storage medium of claim 7 where the entity is an organization.

10. The non-transitory computer-readable storage medium of claim 7 wherein the identifying is based on a context, the context being associated with the identity of the entity.

11. The non-transitory computer-readable storage medium of claim 7 wherein each of the transactions and the interactions are associated with a type and wherein the monitoring is performed based on the type.

12. The non-transitory computer-readable storage medium of claim 7, wherein the method further comprises:
creating one or more views of the macro profile, each view corresponding to an information technology system through which the macro profile can be accessed;
allowing access the macro profile in accordance with one or more placement policies for the information technology system through which the macro profile can be accessed.

13. A system comprising:
memory operable to store at least one program; and
at least one processor communicatively coupled to the memory, in which the at least one program, when executed by the at least one processor, causes the at least one processor to:
identify attribute data associated with an entity from one or both of (1) one or more public domain information sources and (2) one or more private domain information sources;
generate one or more micro profiles for the entity based on the identified data, each of the micro profiles describing the entity in a single dimension;
monitor one or both of (1) transactions associated with the entity and (2) interactions between the entity and one or more other entities;
select a plurality of the generated micro profiles for the entity;
associate the selected micro profiles to generate a macro profile for the entity, the macro profile describing the entity in multiple dimensions;
analyze the one or both monitored transactions and monitored interactions to identify any discrepancies in the macro profile; and
update the macro profile to account for the identified discrepancies.

14. The system of claim 13 where the entity is an individual.

15. The system of claim 13 where the entity is an organization.

16. The system of claim 13 wherein the identifying is based on a context, the context being associated with the identity of the entity.

17. The system of claim 13 wherein each of the transactions and the interactions are associated with a type and wherein the monitoring is performed based on the type.

18. The system of claim 13, wherein the processor is further caused to:
create one or more views of the macro profile, each view corresponding to an information technology system through which the macro profile can be accessed;
allow access the macro profile in accordance with one or more placement policies for the information technology system through which the macro profile can be accessed.
